(19) United States
(12) Patent Application Publication
(10) Pub. No.: US 2004/0120223 A1
(43) Pub. Date: Jun. 24, 2004

(54) Timepiece movement

(76) Inventor: Tai Wai Luk, Hong Kong (CN)

Correspondence Address: SMITH-HILL AND BEDELL, 12670 N W BARNES ROAD, SUITE 104, PORTLAND, OR, 97229

(21) Appl. No.: 10/326,461

(22) Filed: Dec. 20, 2002

(51) Int. Cl. G04B 19/02

(52) U.S. Cl. 368/220

(57) ABSTRACT

A timepiece movement (10) is disclosed as including an hour-wheel (12) with an hour-shaft (12a) to which an hour-hand is securable, a minute-wheel (14) with a minute-shaft (14a) to which a minute-hand is securable, a seconds-wheel (16) with a seconds-shaft (16a) to which a seconds-hand is securable, a light emitter (18) for emitting light, and a light receiver (20) for receiving the light emitted by the light emitter (18), in which the hour-shaft (12a) includes a first aperture (12b), the minute-shaft (14a) includes a second aperture (14b) and the seconds-wheel (16) includes a third aperture (16b), and the apertures (12b, 14b, 16b) allow the light emitted by the light emitter (18) to pass through, and to be received by the light receiver (20) only when the hour-wheel (12), the minute-wheel (14) and the seconds-wheel (16) are in a respective predetermined reference position.

### BACKGROUND OF THE INVENTION

This invention relates to a timepiece movement and, more particularly, a timepiece movement which can detect when an hour wheel and a minute wheel are in predetermined reference positions, e.g. at the 12 o'clock position (i.e. 12 hours and zero minute), detect any difference between the time at which this 12 o'clock time is displayed and the actual time, e.g. as received from an external source by a receiver of the timepiece, and correct any error in the time displayed by the timepiece.

There are in existence a number of prior arrangements of timepiece movements. U.S. Pat. No. 4,645,357 issued to Allgaier et al. discloses a timepiece which receives an externally transmitted radio signal corresponding to an accurate time of day. Disposed within the timepiece is a detecting mechanism for detecting the time of day being displayed by the timepiece. The signals are compared to determined the accuracy of the timepiece. The detection mechanism comprises an optoelectrical system which includes an emitter for directing a beam of radiation towards a sensor. The wheel of the gearworks intersect the beam ahead of the sensor to normally block the beam from the sensor. The wheels include orifices which, when aligned with the beam, permit the beam to reach the sensor, thereby providing an indication of the position of the wheels, and thus of the time being displayed.

U.S. Pat. No. 5,231,612, also issued to Allgaier et al., discloses a radio-controlled timepiece with a mechanism for the detection and correction of a hands setting. A hands setting mechanism includes an hour wheel, a minute wheel, and a second wheel, each possessing an aperture therethrough. The hour wheel has a front mirror located proximate a beam sender for reflecting a beam to a receiver. The front mirror has an interruption defined by the aperture of the hour wheel in order to pass the beam through that aperture to a rear mirror disposed remote from the beam sender, such that a beam reflects from the rear mirror only after passing through aligned apertures in the wheels. The hour wheel is movable independently of the minute wheel and seconds wheel, and the minute wheel and seconds hand are rotatably interconnected.

U.S. Pat. No. 5,566,140 issued to Kohata et al. discloses a clock movement including a circuit board, first and second motors, a minute wheel connected to the first motor by a first gear train and an hour wheel connected to the second motor by a second gear train. A first detection device detects when the minute hand is in a predetermined reference position and a second detection device detects when the hour hand is in a predetermined reference position. The first detection device includes a minute detection sensor mounted on the circuit board and having a first light-emitting device and a first light-receiving device. The second detection device includes an hour detection sensor mounted on the circuit board and having a second light-emitting device and a second light-receiving device.

U.S. Pat. No. 5,930,205 issued to Baba et al. discloses a timepiece movement comprising a light-emitting device for emitting light and a light-receiving device for receiving the light emitted by the light-emitting device. An hour wheel has a number of apertures through which light from the light-emitting device may pass. A minute hand has an aperture through which light from the light-emitting device may pass, the aperture being positioned to become aligned with respective ones of the apertures of the hour wheel during rotation of the minute and hour wheels. Minute and hour wheel gear trains respectively rotate the minute wheel and the hour wheel as a function of minute and hour time.

The contents of these prior art documents are incorporated by reference herein.

In these conventional arrangements, the light passes through apertures provided on the hour wheels and minute wheels. As there is a relatively large gap between these wheels, there will be loss due to light refraction. Some of these prior arrangements, e.g. the timepiece movements disclosed in U.S. Pat. Nos. 4,645,357 and 5,566,140, include two sets of light-emitting members and light-receiving members, which adds to the cost of production.

It is thus an object of the present invention to provide a timepiece movement in which the aforesaid shortcomings are mitigated, or at least to provide a useful alternative to the trade and public.

### SUMMARY OF THE INVENTION

According to a first aspect of the present invention, there is provided a timepiece movement including at least a first wheel with a shaft to which an hour-hand or a minute-hand is securable; a signal emitter adapted to emit signals; and a signal receiver adapted to receive said signals emitted by said signal emitter; wherein said shaft includes an aperture allowing said signals emitted by said signal emitter to pass through when said first wheel is in a predetermined reference position.

According to a second aspect of the present invention, there is provided a timepiece including a timepiece movement, said timepiece movement including at least a first wheel with a shaft to which an hour-hand or a minute-hand is securable; a signal emitter adapted to emit signals; and a signal receiver adapted to receive said signals emitted by said signal emitter; wherein said shaft includes an aperture allowing said signals emitted by said signal emitter to pass through when said first wheel is in a predetermined reference position.

### BRIEF DESCRIPTION OF THE DRAWINGS

A preferred embodiment of the present invention will now be described, by way of an example only, with reference to the accompanying drawings, in which:

FIG. 1 is a partial sectional view of a timepiece movement according to the present invention;

FIG. 2 is a side view of an hour-wheel of the timepiece movement shown in FIG. 1;

FIG. 3 is a side view of a minute-wheel of the timepiece movement shown in FIG. 1;

FIG. 4 is a top view of a seconds-wheel of the timepiece movement shown in FIG. 1; and

FIG. 5 is a block diagram of a microcontroller unit suitable for use in the timepiece movement shown in FIG. 1.

### DETAILED DESCRIPTION OF THE PREFERRED EMBODIMENT

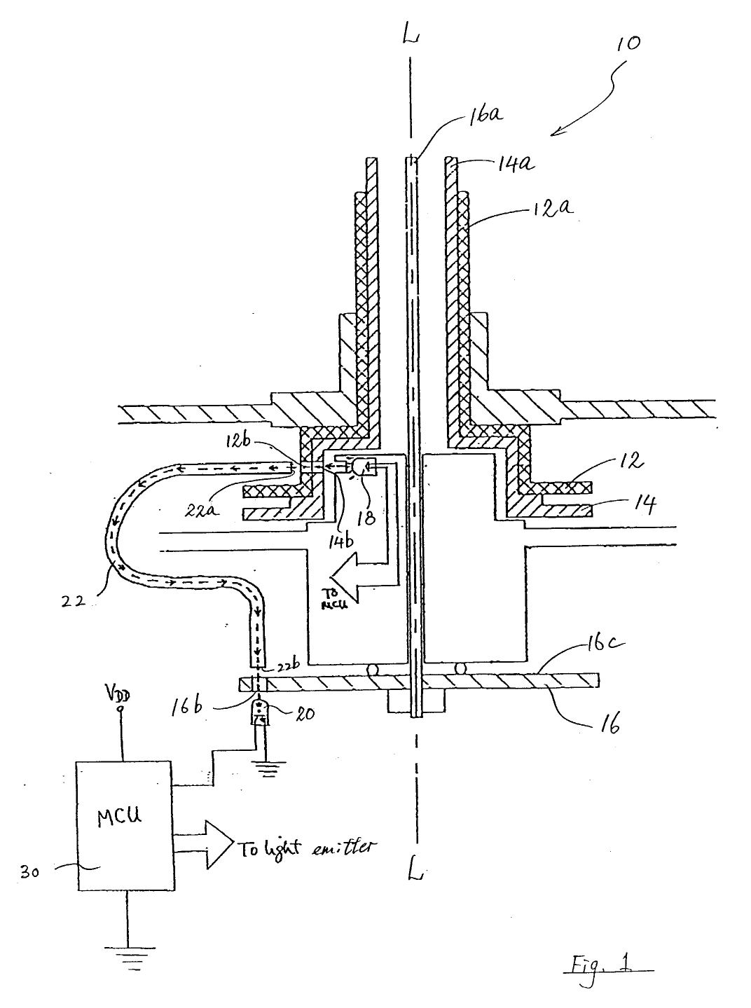

A partial sectional view of a timepiece movement, e.g. a movement for a watch, according to the present invention is shown in FIG. 1, and generally designated as 10.

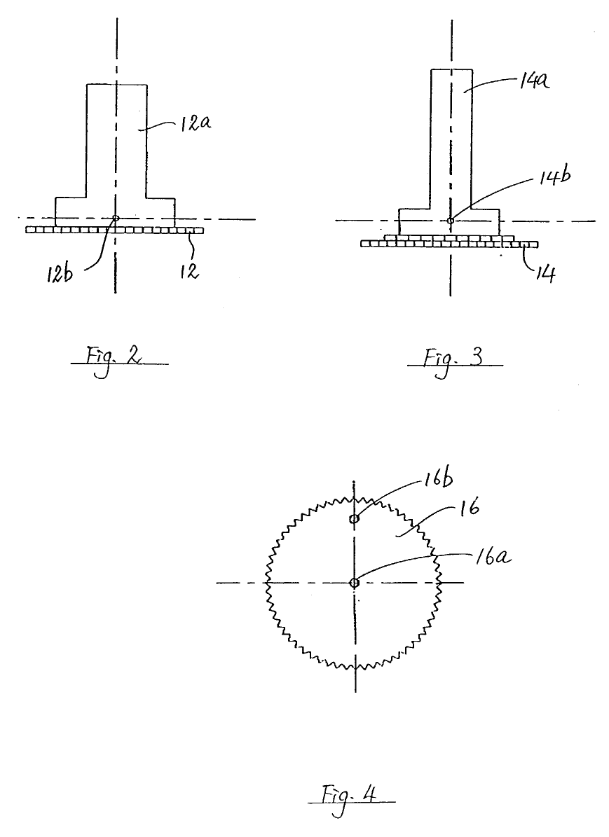

The timepiece movement 10 includes an hour-wheel 12 fixedly secured with a hollow hour-shaft 12a, to which an hour-hand (not shown) may be fixedly secured. The hour-wheel 12 is rotatable by a motor (not shown) as a function of hour time. As can be seen more clearly in FIG. 2, near the bottom of the hour-shaft 12a is provided with a small opening 12b, the function of which will be discussed below.

The timepiece movement 10 also includes a minute-wheel 14 fixedly secured with a hollow minute-shaft 14a, to which a minute-hand (not shown) may be fixedly secured. The minute-wheel 14 is rotatable by a motor (not shown) as a function of minute time. The minute-shaft 14a is sized and configured to be receivable within the hollow hour-shaft 12a for co-axial rotational movement about a longitudinal axis L-L, which is parallel to the longitudinal axis of the hour-shaft 12a and that of the minute-shaft 14a. As in the case of the hour-shaft 12a, and as shown in FIG. 3, near the bottom of the minute-shaft 14a is provided with a small opening 14b. The positions of the small openings 12b and 14b are such that when the hour-wheel 12 and the minute-wheel 14 are assembled for co-axial rotational movement about the axis L-L, the openings 12b and 14b may be rotated into alignment with each other to collectively form a continuous and straight channel, the function of which will be discussed below.

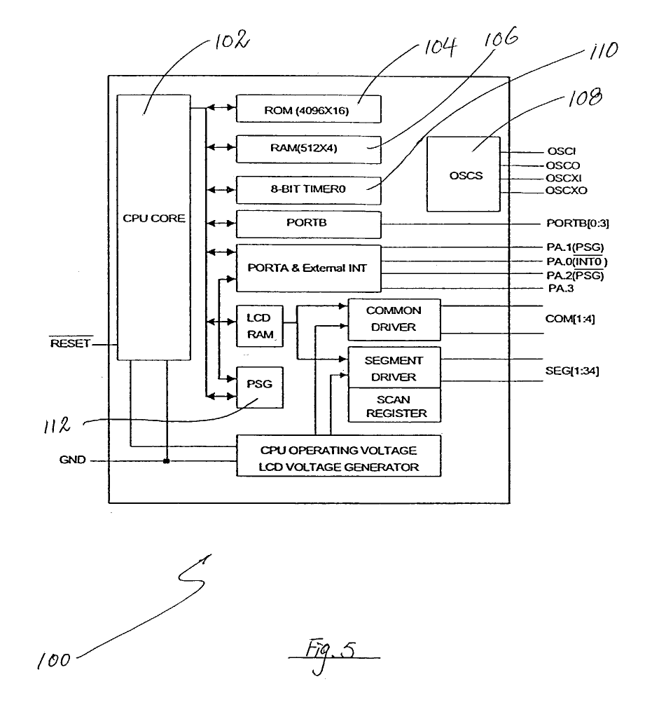

The timepiece movement 10 further includes a seconds-wheel 16 fixedly secured with a seconds-shaft 16a, to which a seconds-hand (not shown) may be fixedly secured. The seconds-wheel 16 is rotatable by a motor (not shown) as a function of second time. The seconds-shaft 16a is receivable within the hollow minute-shaft 14a for co-axial rotational movement about the axis L-L. As can be seen in FIG. 4, through the seconds-wheel 16 is provided with a small opening 16b, the function of which will be discussed below.

Returning to FIG. 1, such shows the timepiece movement 10 in which the hour-wheel 12, the minute-wheel 14 and the seconds-wheel 16 are assembled for co-axial rotational movement about the axis L-L. A light emitter 18, e.g. a light-emitting diode for emitting light and a light receiver 20 for receiving and detecting the light emitted by the light emitter 18 are connected with and controlled by a microcontroller unit (MCU) 30. While a wide variety of microcontroller units are suitable for the present purpose, an appropriate microcontroller unit may be one traded by Novatek Microelectronics Corp., Ltd., of Taiwan, under Model No. NT6613.

It can be seen in FIG. 1 that the light emitter 18 is positioned at the level of the openings 12b, 14b and next to the opening 14b. Next to the opening 12b is provided with an optical fibre 22, whose one end 22a is close to the opening 12b for receiving light emitted by the light emitter 18 and transmitted through the openings 12b, 14b. Another end 22b of the optical fibre 22 is close to an upper surface 16c of the seconds-wheel 16. The light receiver 20 is positioned vertically below the end 22b of the optical fibre 22, for receiving the light transmitted through the optical fibre 22.

During the rotation of the seconds-wheel 16, the opening 16b will be brought into rotational movement about the longitudinal axis of the seconds-shaft 16a, which coincides with the axis L-L. The opening 16b is so positioned that, once every revolution of the seconds-wheel 16, the opening 16b will be brought between the end 22b of the optical fibre and the light receiver 20, thus providing a clear line-of-sight between the end 22b of the optical fibre and the light receiver 20. When the seconds-wheel 16 is in this position, light transmitted by the optical fibre 22 can be received, and thus detected, by the light receiver 20.

During the operation of the timepiece movement 10, the light emitted by the light emitter 18 will normally not reach, and thus not detected by, the light receiver 20, because of blocking by the minute-shaft 14a, and/or the hour-shaft 12a, and/or the seconds-wheel 16. Only when the hour-wheel 12, the minute-wheel 14 and the seconds-wheel 16 are in the position as shown in FIG. 1 will the light emitted by the light emitter 18 be receivable and detectable by the light receiver 20. In this particular position, the openings 12b, 14b are aligned with each other to form a continuous and straight channel next to the light emitter 18, allowing the light emitted by the light emitter 18 to pass through in a direction perpendicular to the axis L-L, and be received by the optical fibre 22, through its end 22a. The light so received is transmitted via the optical fibre 22 to its another end 22b. As, in this position, the opening 16b is positioned between the end 22b of the optical fibre 22 and the light receiver 20, the light so transmitted by the optical fibre 22 will be transmitted through the opening 16b in a direction parallel to the axis L-L, and be received and detected by the light receiver 20.

The hour-hand, minute-hand and seconds-hand are arranged such that when the hour-wheel 12, the minute-wheel 14 and the seconds-wheel 16 are in the respective position as shown in FIG. 1, the time displayed is meant to correspond to 12 o'clock, 0 minute, 0 second or 24 o'clock, 0 minute, 0 second. Once light is received by the light receiver 20, a signal will be sent to the MCU 30. The MCU 30 will then check radio signals received by a receiver (not shown) from an external source corresponding to the accurate time of the day. The signals are then compared with the time when the signal indicative of the reception or detection of light by the light receiver 20. Corrective actions are then carried out to bring the hour-hand and/or the minute-hand and/or the seconds-hand to the respective correct position to show the correct time of the day, as is well known in the conventional manner. For example, if when the hour-wheel 12, the minute-wheel 14 and the seconds-wheel 16 are in the respective position as shown in FIG. 1, i.e. when the hour-hand, the minute-hand and the seconds-hand are aligned, the actual time is 1 o'clock, the MCU 30 will generate 60×60 (3,600) pulses (each pulse representing one second) to drive the hour-hand, the minute-hand and the seconds-hand to the 1 o'clock position.

Turning to FIG. 5, a block diagram of an exemplary microcontroller unit 100 appropriate for use as the MCU 30 in the timepiece movement 10 is shown. The unit 100 includes, among other components:

a. a central processing unit (CPU) core 102, containing the following function blocks: program counter, arithmetic logic unit (ALU), carry flag, accumulator, table branch register, data pointer and stack;

b. a 4096×16 bit read-only-memory (ROM) 104;

c. a random access memory (RAM) 106, containing general-purpose data memory, liquid crystal display (LCD) RAM, and system registers;

d. an oscillator module 108, with two on-chip oscillation circuits OSC and OSCX;

e. an 8-bit timer 110, which consists of an 8-bit up counter and an 8-bit preload register. The timers provide programmable internal timer function and read the counter values; and

f. a programmable sound generator (PSG) 112;

It can be seen that the present invention includes at least the following advantages over the prior art arrangements. As the gap between the hour-shaft 12a and the minute-shaft 14a is very small, when compared with the gap between the hour-wheel and the minute-wheel, light refraction loss is thus minimized. As the optical fibre 22 is bendable, it makes possible the alignment of shafts and gears in different positions of the timepiece movement 10. Only a single light beam is used for alignment of the hour-hand, the minute-hand and the seconds-hand, and only one set of light emitter and light receiver is used.

The present invention also allows pre-set alarm function, in which a user may program the MCU 30, to cause the timepiece to generate an alarm, e.g. sound, at a certain pre-determined time, e.g. 3 o'clock, every day.

It should be understood that the above only illustrates an example whereby the present invention may be carried out, and that various modifications and/or alterations may be made thereto without departing from the spirit of the invention. For example, while the invention is explained above with reference to a timepiece with an hour-shaft, a minute-shaft and a seconds-shaft, it is equally applicable to a timepiece with an hour-shaft and a minute-shaft only.

It should also be understood that various features of the invention which are, for brevity, described here in the context of a single embodiment, may be provided separately or in any appropriate sub-combinations.

What is claimed is:

1. A timepiece movement including:
at least a first wheel with a shaft to which an hour-hand or a minute-hand is securable;
a signal emitter adapted to emit signals; and
a signal receiver adapted to receive said signals emitted by said signal emitter;
wherein said shaft includes an aperture allowing said signals emitted by said signal emitter to pass through when said first wheel is in a predetermined reference position.

2. A timepiece movement according to claim 1 wherein said signals emitted by said signal emitter is light.

3. A timepiece movement according to claim 2 wherein said light emitted by said signal emitter is adapted to pass through at least a length of optical fibre before being received by said signal receiver.

4. A timepiece movement according to claim 1 wherein, when said first wheel is in said predetermined reference position, said signal emitter is adapted to emit signals to pass through said aperture of said shaft in a direction substantially perpendicular to a longitudinal axis of said shaft.

5. A timepiece movement according to claim 1 wherein said first wheel is an hour-wheel adapted to be driven to rotate as a function of hour time.

6. A timepiece movement according to claim 5 further including a second wheel rotatable co-axially with said first wheel.

7. A timepiece movement according to claim 6 wherein said second wheel is a minute-wheel adapted to be driven to rotate as a function of minute time.

8. A timepiece movement according to claim 6 wherein said second wheel is secured with a shaft including an aperture.

9. A timepiece movement according to claim 8 wherein said aperture of said shaft of said second wheel allows said signals emitted by said signal emitter to pass through when said second wheel is in a predetermined reference position.

10. A timepiece movement according to claim 8 wherein when said first and second wheels are in their respective predetermined reference positions, their respective apertures are aligned to form a straight channel allowing said signals emitted by said signal emitter to pass through.

11. A timepiece movement according to claim 2 further including a third wheel with an aperture allowing said light passing through said aperture of said shaft of said first wheel to pass through when said third wheel is in a predetermined reference position.

12. A timepiece movement according to claim 11 wherein when said third wheel is in its said predetermined reference position, said signals emitted by said signal emitter are adapted to pass through said aperture of said third wheel in a direction substantially parallel to said longitudinal axis of said shaft of said first wheel.

13. A timepiece movement according to claim 12 wherein said third wheel is a seconds-wheel adapted to be driven to rotate as a function of second time.

14. A timepiece movement according to claim 1 wherein said signal emitter and said signal receiver are controlled by a microcontroller unit.

15. A timepiece including a timepiece movement according to claim 1.
